(19) United States
(12) Patent Application Publication
(10) Pub. No.: US 2020/0120146 A1
(43) Pub. Date: Apr. 16, 2020

(54) Application Server for Dynamic IMS CSCF Overload Protection

(71) Applicant: Comcast Cable Communications, LLC, Philadelphia, PA (US)

(72) Inventors: Matthew J. Christopher, Highlands Ranch, CO (US); Raghavendra P. Hegde, Wayne, PA (US)

(21) Appl. No.: 16/157,250

(22) Filed: Oct. 11, 2018

(51) Int. Cl. H04L 29/06; H04L 29/12

(52) U.S. Cl. CPC H04L 65/1063; H04L 65/1016; H04L 65/1046; H04L 61/1511; H04L 65/1073; H04L 61/3095; H04L 65/105

(57) ABSTRACT

Systems, apparatuses, and methods are described for tracking a number of computing devices associated with a particular element within a network. A registration count application server may keep track of the total number of devices associated with one or more network elements. The registration count application server may audit registered device counts to determine network elements that may have an associated device count greater than a threshold.

### BACKGROUND

An Internet Protocol (IP) Multimedia Subsystem or IP Multimedia Core Network Subsystem (IMS) comprises a framework for delivering IP multimedia services, which may include a combination of voice, video, messaging, data, etc. within a session. A variety of different types of IMS devices (e.g., user equipment, mobile phones, smartphones, personal digital assistants (PDAs), tablets, and computers) may be used for different types of network-based communication and may be provided with services by IMS Core Networks.

A count of a number of users registered to use particular servers or other network devices is helpful to ensure the total number of users served by a particular IMS element, such as a particular server, is within limits defined for that element. If an IMS element is serving too many users, the IMS element may become overloaded, which could result in a system failure affecting all users registered with that IMS element.

### BRIEF SUMMARY

The following summary presents a simplified summary of certain features. The summary is not an extensive overview and is not intended to identify key or critical elements.

Systems, apparatuses, and methods are described for maintaining an accurate count of a number of users, or pieces of user equipment, registered with a particular IMS element within an IMS system. A Registration Count Application Server (RegCount AS) may keep track of the total number of registered devices on a particular IMS element instance in order to ensure a device count is within the permissible limits defined for that IMS element instance. If the registered device count goes beyond certain thresholds defined for the IMS element instance, the RegCount AS may trigger movement of the devices to a different IMS element instance to bring the count within permissible limits.

A registered device count audit and a Domain Name System (DNS) server update process may be utilized to keep track of the devices registered with an IMS Call Session Control Function (CSCF). The RegCount AS may audit device counts to identify any IMS CSCF instances that have registered device counts greater than associated threshold values. The RegCount AS may update DNS entries to de-prioritize an oversubscribed IMS CSCF instance. A device attempting to register with the IMS core after the DNS is updated may be directed to a different IMS CSCF instance.

### BRIEF DESCRIPTION OF THE DRAWINGS

Some features are shown by way of example, and not by limitation, in the accompanying drawings. In the drawings, like numerals reference similar elements.

FIG. 1 shows an example system architecture.

FIG. 2 shows example message flows for IMS Registration.

FIG. 3 shows example message flows for device registration count tracking.

FIG. 4 shows example message flows for device registration auditing and DNS updating.

FIG. 5 shows example message flows for a RegCount AS auditing and DNS updating with a network-initiated deregistration.

FIG. 6 is a flow chart showing an example of device registration count tracking.

FIG. 7 is a flow chart showing an example of RegCount AS auditing.

FIG. 8 shows an example RegCount AS cluster architecture.

FIG. 9 shows an example device architecture.

### DETAILED DESCRIPTION

The accompanying drawings, which form a part hereof, show examples of the disclosure. It is to be understood that the examples shown in the drawings and/or discussed herein are non-exclusive and that there are other examples of how the disclosure may be practiced.

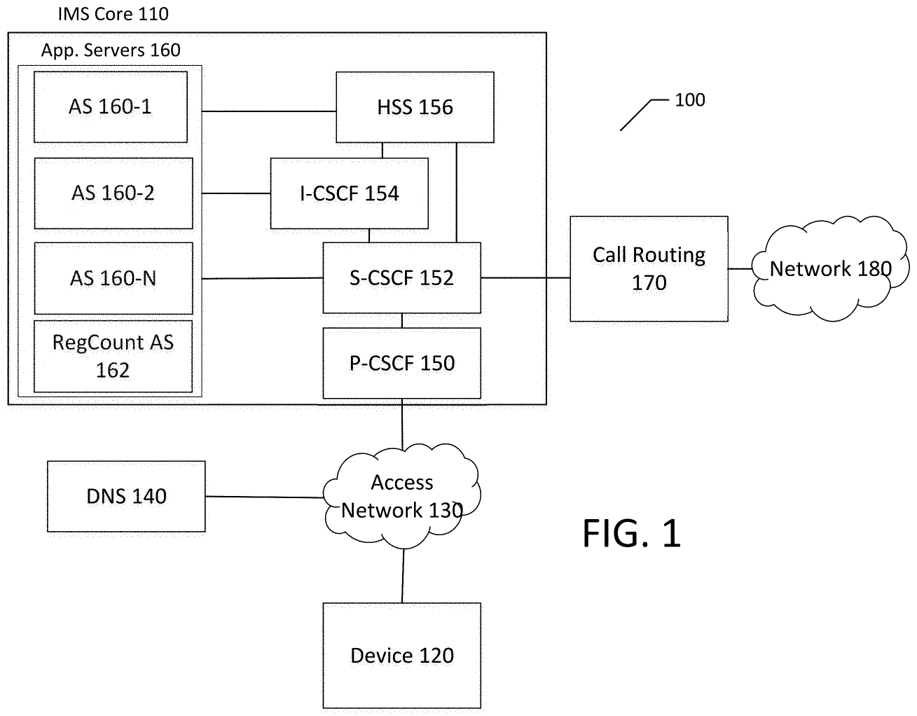

FIG. 1 shows a network architecture and data processing device that may be used to implement one or more features described herein. A home network system 100 may include an IMS core 110, which may be in communication with a device 120 via an access network 130. The device 120 may comprise any device, such as, for example, a computer (e.g., a laptop, notebook, desktop, or other computer), a wireless device, a mobile device, a handset, an internet of things (IoT) device, a hotspot, a cellular repeater, user equipment and/or, more generally, a computing device. The device 120 performs a discovery process using the DNS server(s) 140. Although a single device 120 is shown in FIG. 1 for simplicity, multiple of the devices 120 may interact with each IMS core 110.

Various network nodes 110, 120, 140, 170, and 180 may be interconnected via a wide area network (WAN), such as the Internet. Other networks may also or alternatively be used, including, without limitation, private intranets, corporate networks, local area networks (LANs), wireless networks, and/or personal networks (PAN). The access network 130 may be replaced with fewer or additional computer networks. A LAN may have one or more of any known LAN topology and may use one or more of a variety of different protocols, such as Ethernet. The devices 110, 120, 140, 170, and 180 and other devices therein may be connected to one or more of the networks via twisted pair wires, coaxial cable, fiber optics, radio waves or other communication media.

The device 120 may identify, through the use of one or more domain name system (DNS) server(s) 140, a particular Call Session Control Function (CSCF) server of the IMS core 110. The IMS core 110 may provide services based on a plurality of standards. As examples, 3GPP, which is a wireless industry base standard, and PacketCable 2.0, which is a Multiple System Operator (MSO) base standard, may be used with the IMS core 110. The CSCF system may be made up of three parts, P(proxy) 150, S(session) 152 and I(interrogating) 154, and each of those three CSCF functions may have pre-defined roles and pre-defined interfaces and pre-defined functions. Each instance of the IMS elements (e.g. Proxy, Session, and/or Interrogation elements) may comprise one or more of: a physical device, an element, software, program modules, computer functionality, a system module, a user agent, server, data storage devices, and the like. Software features may be implemented in whole or in part in as routines, programs, objects, components, data structures, etc. that perform particular tasks or implement particular abstract data types when executed by a processor in a computer or other device. The functionality may be implemented in whole or in part in firmware or hardware equivalents such as integrated circuits, field programmable gate arrays (FPGA), programmable logic controllers or devices, and the like. After an end-user picks up a phone, a number may be dialed and those digits may be injected into a session initiation protocol (SIP) invite message. That same invite may be passed across different Call Session Control Function elements. The different Call Session Control Function proxies serve different, specific functions, but may each be involved in the call path for both call setup and call tear down. If any single proxy were to fail, the call may fail.

The device 120 may comprise an embedded digital voice adapter (EDVA), which may be user premises equipment EDVA, which may implement the PacketCable 2.0 protocol. The EDVA may be a voice line card that may be part of a Data Over Cable Service Interface Specification (DOCSIS) cable modem, which may be part of a gateway situated at the user premises. The access network 130 may comprise a wired, optical, hybrid-fiber coaxial and/or other type of network. The access network 130 may comprise a wireless radio access network such as a mobile telecommunication system, such as Evolved Universal Terrestrial Radio Access (E-UTRA), Long-Term Evolution (LTE), LTE-Advanced, 5G, or Global System for Mobile Communications (GSM) networks, a Wi-Fi network or other network according to an IEEE 802.11 standard, or other type of wireless network. The access network 130, which may include a cable modem termination system (CMTS), may be part of a physical data plane and control plane interface.

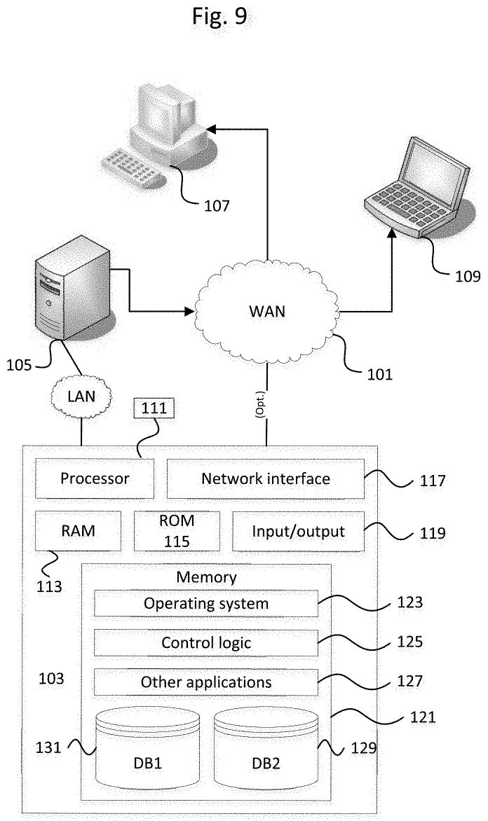

The Proxy-CSCF (P-CSCF) 150 may face the access network 130 and may provide a variety of different network functions. For example, the P-CSCF 150 may perform network address translation (NAT) (e.g. between different IP spaces) or firewall functions. The P-CSCF 150 may be implemented as a server 103 discussed below with regards to FIG. 9. The P-CSCF 150 may be the initial entry point into a trusted network (e.g., of a service provider), and may be located either in a visited IMS network being accessed from the access network 130 (in full IMS networks) or in a home network (if the visited network is not IMS compliant yet). The P-CSCF 150 may handle user authentication, validate the device 120 as authorized, and handle exchanges of security keys as part of the registration process. Some networks may use a Session Border Controller (SBC) for these functions. The P-CSCF 150 may function as a specialized SBC for the user-network interface which protects the network and the IMS terminal. The device 120 may discover a particular P-CSCF 150 via a DNS lookup (e.g., via the DNS server(s) 140). The lookup procedure may use Dynamic Host Configuration Protocol (DHCP), or may be configured (e.g. during initial provisioning or via a 3GPP IMS Management Object (MO)) or in the IP Multimedia Services Identity Module (ISIM) or assigned in the PDP Context (for General Packet Radio Service (GPRS)). The device 120 may send a query to a Dynamic Host Configuration Protocol (DHCP) server for retrieving the IP addresses and the Fully Qualified Domain Name (FQDN) of the P-CSCF 150. The device 120 may use the P-CSCF 150 FQDN, which it obtained during the DHCP procedures, in the DNS look up to receive the IP address of the P-CSCF 150 associated with that FQDN.

The IMS core 110 may include a plurality of P-CSCFs 150. Each P-CSCF 150 may be assigned to a device 120 before registration, and does not need to change for the duration of the registration. The assignment may be based on geography. For example, a user in a western part of a serviced region may register to a west region based P-CSCF 150.

The P-CSCF 150 may be in the path of all signaling for the device 120, and may inspect every signal. The P-CSCF 150 may provide user authentication and may establish a security association with an IMS terminal or user equipment (e.g. the device 120). Although a single P-CSCF 150 is shown in FIG. 1 for simplicity, there may be multiple P-CSCFs 150 in the IMS core 110 for load distribution and to provide high availability of services. The P-CSCF 150 may be responsible for inspecting signals entering the IMS core 110. For example, the P-CSCF 150 may inspect packets to ensure that signals from IMS terminals maintain normal signaling routes. The P-CSCF 150 may include a Policy Decision Function (PDF), which authorizes media plane resources, e.g., quality of service (QoS), over the media plane. The PDF may be used for policy control, bandwidth management, etc. The PDF may also be a separate function. The P-CSCF 150 may also generate charging records for use in billing.

A Serving-CSCF (S-CSCF) 152 may be the central node of the signaling plane, may be a SIP server, and may perform session control. The S-CSCF 152 may be implemented as server 103 discussed below with regards to FIG. 9. The S-CSCF 152 may make some call-routing decisions and may invoke application servers. The S-CSCF 152 may be located in the home network. The S-CSCF 152 may use Diameter interfaces to a Home Subscriber Server (HSS) 156 to download user profiles and upload user-to-S-CSCF associations. All necessary user profile information may be loaded from the HSS 156. The S-CSCF 152 may handle SIP registrations, which allows it to bind the user location (e.g., the IP address of a terminal) and the SIP Address of Record (AOR). The S-CSCF 152 may be connected to a number of the call routing and interconnection modules 170, which are in turn connected to an outside network 180.

The S-CSCF 152 may be in the path of all signaling of the locally registered devices, and may inspect every message. The S-CSCF 152 may decide to which application server(s) 160 a SIP message may be forwarded, in order to provide application services. The S-CSCF 152 may provide routing services, e.g. using E.164 Number to URI Mapping (ENUM) lookups. The S-CSCF 152 may enforce the policy of the network operator. Although a single S-CSCF 152 is shown in FIG. 1 for simplicity, there may be multiple S-CSCFs 152 in the IMS core 110 for load distribution and to provide high availability of services. The HSS 156 may assign the S-CSCF 152 to a user, after the HSS 156 is queried by an Interrogating-CSCF (I-CSCF) 154. The S-CSCF 152 also may communicate with other call routing and interconnection elements 170, such as Session Border Controllers, to connect to the outside networks 180, and may provide communication between the devices 120 in the home network 100 and the devices 120 or other devices in the outside networks 180.

The Interrogating-CSCF (I-CSCF) 154 may perform other SIP functions for the IMS core 110 and may be located at the edge of an administrative domain. The I-CSCF 154 IP address may be published in the DNS server(s) 140 of the domain (using Name Authority Pointer (NAPTR) and service record (SRV) type of DNS records), so that any remote servers may find it, and use it as a forwarding point (e.g., registering) for SIP packets to this domain. The I-CSCF 154 may query the HSS 156 to retrieve the address of the S-CSCF 152 and assign the S-CSCF 152 address to a user performing SIP registration. The I-CSCF 154 may also forward SIP requests or responses to the S-CSCF 152. The I-CSCF 154 may be implemented as server 103 discussed below with regards to FIG. 9. Although a single I-CSCF 154 is shown in FIG. 1 for simplicity, there may be multiple I-CSCFs 154 in the IMS core 110 for load distribution and to provide high availability of services.

The HSS 156 may be a master user database that supports the IMS network entities that actually handle calls. The HSS 156 may contain the IMS subscription-related information (user profiles), may perform authentication and authorization of users, and may provide information about users locations and IP information.

The I-CSCF 154 may be used to hide the internal network from the outside world (encrypting parts of the SIP message), as a Topology Hiding Inter-network Gateway (THIG). That function may also be implemented as part of the Interconnection Border Control Function (IBCF). The IBCF may be used as gateway to external networks, and to provide NAT and firewall functions (e.g. pinholing). The IBCF may be a Session Border Controller specialized for the network-to-network interface (NNI).

The IMS core 110 may also include a plurality of application servers 160. A Telephony Application Server (TAS) may be used by residential IMS users for feature processing, such as call holding, call dialing, or any other feature processing for residential users. A Business Application Server (BAS) may be used to provide services for business users. For example, a law firm may have different office locations and a common home network 100 that are part of one business group, all of which may be served by a single or distributed BAS, which may include applications and/or services customized for the business. Any features, such call forwarding, extension dialing, or any other business features may be served by the Business Application Server. A Communication Application Server (CAS) may be used for other application services, such as a TV call notification service. For example, a home network 100 user who has WiFi and TV services may receive a notification, generated by the CAS, about an identity of a caller may be displayed on a TV.

The servers 140, 150, 152, 154, 156, 160 and 162 may provide overall access, control and administration of databases and control software for performing one or more operations described herein. The servers may be connected to other intermediary servers (not shown) through which users interact with and obtain data as requested. Additionally or alternatively, one or more of the servers may act as a web server and may be directly connected to the Internet. The servers 140, 150, 152, 154, 156, 160 and 162 may be connected to devices 120 via the access network 130, via direct or indirect connection, or via some other network (e.g., the Internet). Users may interact with the servers using a remote computer, a mobile device or other user device 120.

The servers and applications may be combined on the same physical machines, and retain separate virtual or logical addresses, or may reside on separate physical machines. The servers may be configured in the same manner as server 103 discussed in greater detail below with regards to FIG. 9. FIG. 1 shows just one example of a network architecture that may be used. The specific network architecture and data processing devices and/or other devices used may vary. For example, services provided by the RegCount AS 162 and another application server may be combined in a single physical device.

As a device 120 registers with a particular P-CSCF 150, a traffic engineer may track, through Key Performance Indicators (KPIs) or reports, a number of devices 120 that are registering to a particular P-CSCF 150 instance based on the entries that are indicated in the DNS server(s) 140. As millions of end point devices 120 may be registered with a particular P-CSCF at any point in time, the volumes generally change gradually. If a P-CSCF 150 is found to be nearing or in an overloaded state, the traffic engineer may update the DNS server(s) 140 to point at least a portion of a specific geographic region to a different P-CSCF 150. The devices 120 may begin to register to the different P-CSCF 150. As such, a portion of the user base of a first P-CSCF 150 may be directed to a different or second P-CSCF 150 to avoid an overload condition in the first P-CSCF 150. The manipulation of DNS entries by an IMS instance or service may allow user equipment or endpoints to be directed to and registered with a new P-CSCF 150.

A Registration Count Application Server (RegCount AS) 162 may be provided in the registration path and may act as a registration counter. The RegCount AS 162 may track how many of the devices 120 are registered to a particular P-CSCF 150. If the number of the devices 120 registered to a P-CSCF 150 reaches a pre-defined capacity threshold or a configurable capacity threshold, the RegCount AS 162 may initiate re-registration requests so the devices 120 would register to a different P-CSCF 150. The different P-CSCF 150 may be an underloaded P-CSCF or may be new P-CSCF that may be added to the system. The re-registration requests effectively balance out the registration across a plurality of the P-CSCFs 150 in the system.

A RegCount AS 162 may keep track of the total number of registered devices on a particular IMS element instance in order to ensure the registered device count is within the permissible limits defined for that IMS element instance. The RegCount AS 162 may have an IMS Service Control (ISC) interface to connect to an IMS element, such as the CSCF servers or proxies; an interface to the DNS servers 140, an interface to any external systems that may be used to update the data stored by the RegCount AS 162, and an interface to the HSS 156. If the registered device count goes beyond the critical thresholds defined for the IMS element instance, the RegCount AS 162 may trigger movement of the devices to a different IMS element instance to bring the count down within permissible limits.

The RegCount AS 162 may be an IMS compliant element within the IMS core 110, and may connect to an IMS instance over the ISC interface. The RegCount AS 162 may maintain, for homogenous IMS element systems, a mapping between the provisioning domain, used by the device 120 to discover a P-CSCF 150 and a S-CSCF 152 with which the device 120 eventually registers. Threshold and critical threshold values of devices 120 for each IMS CSCF instance in the network may be set for IMS CSCF systems.

The IMS CSCF instance may invoke the RegCount AS 162 based on the initial filter criteria (iFC) defined in a user or device profile. After the device 120 registers, the IMS CSCF instance (e.g. the S-CSCF 152) may perform a third party registration on behalf of the device 120 with the RegCount AS 162. The RegCount AS 162 may use the information in the third party registration message to update the registered device count against the IMS CSCF instance provisioned in the RegCount AS 162.

A registered device count audit and DNS update process may be used to keep track of the devices 120 registered with any particular IMS CSCF instance. At a preconfigured periodic interval, the RegCount AS 162 may audit the registered device 120 count, to identify any IMS CSCF instances that have registered device counts greater than the threshold values. That is, the registered device count audit and DNS update process may track the number of users registered with each server or data processing device that is acting as an instance of the IMS core 110, including the P-CSCF 150, the S-CSCF 152, and the I-CSCF 154.

For each associated IMS CSCF instances, the RegCount AS 162 may update the DNS entries to de-prioritize the affected IMS CSCF instance, so that the affected IMS CSCF instance is not selected for device 120 registrations. After the DNS server(s) 140 is updated, the next time a device 120 tries to register, the device 120 may be directed to register with a different IMS CSCF instance (e.g. a secondary P-CSCF 150).

The device count may be reduced on the critically overloaded IMS CSCF instance. If the device registration count of a particular IMS CSCF instance is higher than the defined critical threshold of that IMS CSCF instance, the RegCount AS 162 may update the registration status of the devices 120 in the HSS 156, and may initiate a Network Initiated Deregistration (NID) to force the device 120 to re-register with the IMS CSCF instance(s). For example, the HSS 156 may send a deregistration message that is sent to the S-CSCF 152, which may send a deregistration message to the P-CSCF 150. The deregistration message may include reason for deregistration. The P-CSCF 150 may transmit a deregistration message to the device 120 being deregistered. The device 120 may attempt a new registration, beginning with a new DNS inquiry. The number of devices 120 whose registrations may be terminated may be at least equal to the number of devices that are beyond the threshold. The devices 120 that are approaching the end of their registration expiry timer may be deregistered first.

The HSS 156 may send registration termination requests (RTR) to the IMS CSCF instance for all the devices 120 that need to be moved to a different IMS CSCF instance. In response to receiving the RTR, the IMS CSCF instance may send a network-initiated deregistration (NID) to the affected devices 120. After receiving a NID from the IMS CSCF instance, devices 120 may perform a DNS lookup process to discover the preferred IMS CSCF instance for registration. After the IMS CSCF priorities have been updated in the DNS server(s) 140 by the RegCount AS 162, the device 120 attempting to register may be pointed to a different IMS CSCF instance.

Alternatively, the devices 120 may be subscribed to an overload subscription package during registration. The devices 120 may be notified (e.g., using a SIP Notify message) by the RegCount AS 162 after the IMS CSCF instance, with which the device 120 is registered, reaches its maximum capacity. The devices 120, after receiving such a notification, may register with a different IMS CSCF instance during a re-registration cycle. The RegCount AS 162 may continue to keep track of the device registration count, and send notifications instead of or after updating the DNS server(s) 140. Also, the trigger to send a network-initiated deregistration remains the same.

The IMS core 110 may include a Media Resource Function (MRF), not shown, which may be a media server that provides media related functions such as media manipulation (e.g. voice stream mixing) and playing of tones and announcements. Each MRF may be further divided into a media resource function controller (MRFC) and a media resource function processor (MRFP). The MRFC may be a signaling plane node that interprets information coming from an application server and the S-CSCF 152 to control the MRFP. The MRFP may be a media plane node used to mix, source or process media streams. The MRFP may also manage access rights to shared resources. The Media Resource Broker (MRB) may be a functional entity that may be responsible for both collection of appropriate published MRF information and supplying of appropriate MRF information to consuming entities such as the AS. The MRB may be used in two modes, a Query mode and an In-Line mode. In the Query mode, an application server may query the MRB for media and sets up the call using the response of MRB, and in the In-Line Mode, an application server may send a SIP INVITE to the MRB and the MRB may set up the call.

The IMS core 110 may include a Call Charging Function (CCF), which may be a server that creates and manages a billing record that may be created as calls are made. The billing record may include information such as a calling party, the called party, the duration of the call, and other information associated with the call needed for billing records. That information may be fed into the CCF by other IMS network elements. The billing records may be concealed from all of other IMS network elements.

The call routing and interconnection modules 170, which may in turn be connected to an outside network 180, may include a variety of session border controllers (SBCs), which serve as edge devices that interface the host network with outside networks. The SBCs may help protect the network from another service provider, providing a firewall and network address translation (NAT) functions as needed, and hiding the network topology so that the IP address space of the home network 100 is not exposed to another service provider. Instead, calls from an outside network to the home network may be sent to the home network SBC IP addresses. A Communications Assistance for Law Enforcement Act (CALEA) SBC may be an interface for legal compliance with law enforcement agencies. Other SBCs for public internet access may be used for over the top (OTT) clients that provide the ability to make and receive calls with a home phone number using a smartphone application. A user specific network-to-network interface (NNI) may be provided for syndicating network service such as home networks voice service to third party networks to which the home network needs to connect. The NNI may act as an SBC to talk with a specific connected outside network and interface to their access network. A peering SBC may provide SIP peering and interconnection to least cost routing carriers, including 911 services. A least cost routing carrier may provide call-terminating services for long distance calls not serviced by direct connections. Priority registration may be provided to preferred or required users, such as for compliance with legal or contractual requirements.

The call routing and interconnection modules 170 may also include a SIP Route Proxy (SRP) that may perform normalization and may perform some routing lookup functions and a Border Gateway Control Function (BGCF) that may make call routing decisions. For example, if a call is destined to an outside network user, a BGCF may send the call to the outside network specific session border controller (SBC). A Media Gateway Control Function (MGCF) and Signaling Transfer Point (STP) may provide IP interworking functions. A media gateway (MGW) may be provided as a translation device or service that converts media streams between disparate telecommunications technologies such as plain old telephone service (POTS), SS7, Next Generation Networks (2G, 2.5G, 3G, 4G, and 5G radio access networks), or private branch exchange (PBX) systems. The MGW may enable multimedia communications across packet networks using transport protocols such as Asynchronous Transfer Mode (ATM) and Internet Protocol (IP). A MGW may provide time-division multiplexing (TDM) to IP interworking for carrier networks that cannot be reached via an IP interconnect. Regulatory requirements or network requirements may require interconnects to outside voice service providers through legacy technology. The MGW may provide access to and interconnection with the public switched telephone network (PSTN) or even a POTS.

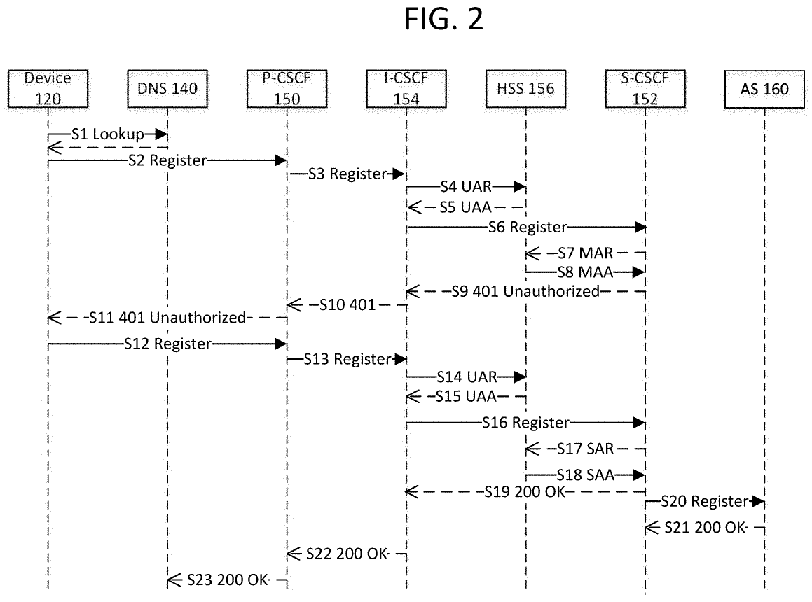

As part of an example IMS Registration process, and as shown in FIG. 2, the device 120 may establish IP connectivity. The device 120 may send a query to the Dynamic Host Configuration Protocol (DHCP) server for retrieving the device 120's IP address. The DHCP response may also include a Fully Qualified Domain Name (FQDN) of the P-CSCF 150. In step S1, the device 120 may perform a series of DNS queries, including performing: 1) NAPTR lookup, 2) SRV lookup and 3) A/AAAA lookup specifying IP address of a given host for IPv4 and IPv6, respectively. In response to the DNS query(ies), the IP address of the P-CSCF 150 may be returned. This may be known as the DHCP-DNS procedure for the P-CSCF 150 discovery. However, in some cases, it may be possible that the FQDN of the P-CSCF 150 may be pre-configured in the device 120. A device 120 with such a preconfiguration may directly query the DNS server 140 and receive the IP address of the P-CSCF 150.

In step S2, the device 120 may send a SIP REGISTER request to the P-CSCF 150 to register the device 120 in the IMS core network. The device 120 may send a SIP INVITE request to the P-CSCF 150 to which the device 120 may be previously registered. The P-CSCF 150, in step S3, may send a registration request to an I-CSCF 154. This may be known as the I-CSCF 154 discovery process. The I-CSCF 154 may send a User-Authorization-Request (UAR), in step S4, to the HSS 156 and may receive, in step S5, a User-Authorization-Answer (UAA) back from the HSS 156. The I-CSCF 154, in step S6, may send the registration request to the S-CSCF 152. The S-CSCF may send, in step S7, a Media-Authorization-Request (MAR) to the HSS 156 and may receive, in step S8, a Media-Authorization-Answer (MAA) from the HSS 156. The S-CSCF 152 may return, at step S9, the 401 unauthorized message to the I-CSCF 154, which may forward, at step S10, the SIP 401 unauthorized message indicating that user authentication may be required to the P-CSCF, which may forward, at step S11, the 401 unauthorized message to the device 120.

At step S12, the device 120 may send a registration message to the P-CSCF 150. The P-CSCF 150 may send a registration request to an I-CSCF 154. The I-CSCF 154 may send, at step S13, a User-Authorization-Request (UAR) to the HSS 156 over a diameter link and may receive a User-Authorization-Answer (UAA) back from the HSS 156. The I-CSCF 154 may send, at step S16, a registration request to the S-CSCF 152. The S-CSCF 152 may send, at step S17, a Server-Assignment-Request (SAR) to the HSS 156 and may receive a Server-Assignment-Answer (SAA) back from the HSS 156. The S-CSCF may return, at step S19, the SIP 200 OK message to the I-CSCF 154.

At step S20, the S-CSCF 152 may send a registration request to an application server (AS) 160, such as a telephony app server (TAS), and may receive the SIP 200 OK message from the AS 160 in step S21. The I-CSCF 154 may send, at step S22, a SIP 200 OK message to the P-CSCF 150, which may forward, at step S23, the SIP 200 OK message to the device 120.

In the process shown in FIG. 2, the number of devices 120 registered with the IMS core 110 may not be tracked. The Registration Count Application Server (RegCount AS) 162 may be provided in the registration path and may act as a registration counter. The RegCount AS 162 may track how many devices 120 are registered to a particular P-CSCF 150. The device 120 may begin its registration process in a normal manner, e.g. by following Steps S1-S19 of FIG. 2. The device 120 may be configured with a Fully Qualified Domain Name (FQDN) and may use a look up procedure with the DNS server(s) 140, in step S31, to discover the identity of the P-CSCF 150. The DNS server(s) 140 may respond to the device 120 lookup with an identification of multiple P-CSCFs, e.g. with a set of IP addresses. A most preferred address may be provided by the DNS server(s) 140, and other addresses may be provided in a preferred order or addresses may be provided with a preference based weight based on factors such as available capacity and geography. For example, after the device 120 may look up the FQDN and may receive a set of IP addresses, the device 120, in step S32, may attempt to register with first IP address. If for any reason that registration does not go through, the device 120 may attempt to register with the next IP address from the list provided by the DNS server(s) 140, until registration with each of the IMS-CSCF instances is complete. Both the device 120 and the IMS core 110 (including components thereof) follow the IMS device registration process to authenticate and authorize the device 120. The device 120 may receive, in step S33, a SIP 200 OK message, which may indicate that the registration process is complete.

To maintain a device 120 registration count, the IMS-CSCF instance such as the S-CSCF 152, in step 34, may register the newly registered device 120 with the RegCount AS 162. The IMS core 110 element, such as the S-CSCF 152, may transmit the third party registration message which may include the complete registration message, from the device 120, in the body of the third party registration message transmitted to the RegCount AS 162. Based on successful registration of the device 120, the 200 OK message may be returned to the IMS core 110 elements, and a 200 OK message may be returned to the device 120 in keeping with registration processes with other application servers. The IMS core 110 element may register user identification information of the device 120 with all of the application servers applicable to the device 120. For example, for a residential user, the IMS core 110 may register the device 120 by performing registration of device 120 through a third party registration process. The user identification information may include information that identifies the device 120 and information that identifies the CSCF instances and other host system devices with which the device 120 may be associated. The S-CSCF 152 may initiate the third party registration for the device 120 with at least the telephony application server (TAS) and any other preferred application services, including with the RegCount AS 162.

In step S34, the third party registration message may be sent by the IMS core 110 element, such as S-CSCF 152, to the RegCount AS 162. The S-CSCF 152 may include the complete device 120 registration message, as sent to the P-CSCF 150, to the RegCount AS 162 as a payload in the body of the third party registration message. The entire registration message may include information such as the device 120 contact information, all of the different paths to the device 120, IP address the device 120 may be using, the assigned P-CSCF 150, the assigned S-CSCF 152, the Initial Filter Criteria (iFC), the Shared iFC (SiFC), and/or other device 120 information. The S-CSCF 152 may send the device 120 phone number (PN) or the Common Public Radio Interface (CPRI) information as part of the third party registration message to the RegCount AS 162. The RegCount AS 162 may include a database of the device 120 registration information, that the RegCount AS 162 may update to reflect any new device 120 registration information. For example, the RegCount AS 162 may look up the device 120's identification information, such as an IMPU, in the local tables. If the IMPU is found, the IMS-CSCF information associated with the IMPU record, such as the assigned P-CSCF 150, may be updated with the IMPU record. Otherwise, the RegCount AS 162 may create a record for a device 120 that was not previously registered. The RegCount AS 162 may update the registration expiry time against the device 120, and may update the device 120 count against any IMS-CSCF instance serving the device 120. The RegCount AS 162 may transmit the 200 OK to the S-CSCF 152.

The RegCount AS 162 may compare the device 120 identification information received in the third party registration information with the device 120 identification information stored in the database of the RegCount AS 162 to determine if a new device record must be created, or if a previously created device record may be updated with any new information. If the RegCount AS 162 has previously registered the device 120, the RegCount AS 162 may update the device 120 information based on the information provided in the payload in the body of the third party registration message. The RegCount AS 162 may update two user count values: the user count of a host device newly associated with the device 120 may be increased, and the user count of the host device previously associated with the device 120 may be decreased in view of a change of the host device associated with the device 120.

The RegCount AS 162 may perform a lookup operation of the device 120's identification information, which may include an IP Multimedia Private Identity (IMPI) or an IP multimedia public identity (IMPU), in a local table or database, to determine if the device 120 has been previously added to the RegCount AS 162 database, before or after responding to the IMS core 110 element with the 200 OK message. If the IMPI, IMPU, or other identification information is found, the RegCount AS 162 may update the assigned CSCF information against the IMPI or IMPU. The IP Multimedia Private Identity (IMPI) may be a unique permanently allocated global identity assigned by the home network operator, it may have the form of an Network Access Identifier (NAI) (e.g. user.name@domain), and may be used, for example, for registration, authorization, administration, and accounting purposes. Every IMS device 120 may have one IMPI. The IP Multimedia Public Identity (IMPU) may be used by any user for requesting communications to other users (e.g. this might be included on a business card), and may also be known as Address of Record (AOR). There may be multiple IMPUs per IMPI. The IMPU may also be shared with another wireless device, so that both may be reached with the same identity (for example, a single phone-number for an entire family).

The RegCount AS 162 may be provisioned with the IMS CSCF instance identity information for each IMS CSCF instance with which it may be associated. That is, the RegCount AS 162 may be configured with information identifying each IMS element with which users may be registered, including the location and capacity of those elements, and this information may be provisioned during an element installation process. The RegCount AS 162 may also be configured with thresholds associated with each IMS element. For example, the RegCount AS 162 may be provisioned with the P-CSCF 150 identity information for each P-CSCF 150 with which it may be associated, to maintain the count of users for each P-CSCF 150 instance, and may be provisioned with the threshold and the critical threshold for each of the P-CSCFs 150.

The P-CSCF 150 threshold may serve as a soft limit for the number of users. For example, a P-CSCF threshold may be set to a percentage of the capacity of the P-CSCF 150. If the number of users for a particular P-CSCF 150 reaches the threshold corresponding to that P-CSCF 150, the RegCount AS 162 may initiate an auditing process. The critical threshold may be the absolute maximum limit for the particular CSCF. The P-CSCF 150 critical threshold may be higher than the P-CSCF 150 base threshold. Beyond the critical threshold, the P-CSCF 150 may go out of service, or may start rejecting calls. To avoid service issues with any P-CSCF 150, the RegCount AS 162 may maintain a count of the number of device 120 registrations. Every time a device 120 registers, the RegCount AS 162 may increase the device 120 count of the corresponding CSCF instance.

Base and critical thresholds for newly identified P-CSCFs 150 may be set by an operator during an installation process based on other base and critical thresholds, respectively, of known P-CSCF 150 instances previously registered in the RegCount AS 162. The base and critical thresholds for newly identified P-CSCFs 150 may be adjusted over time based on a determination that at least one of the base and critical threshold has been satisfied during an auditing process.

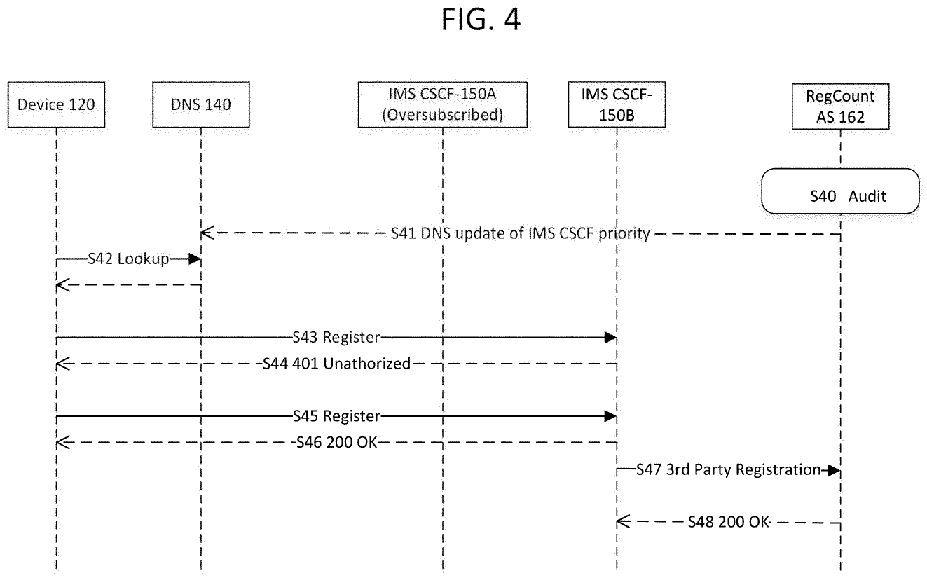

As shown in FIG. 4, the RegCount AS 162, independent of the device 120 registration processes, may perform an audit of at least some IMS elements, as step S40, at a periodic interval. For example, the RegCount AS 162 audit process may determine if any of the monitored IMS elements have reached a registered number of devices 120 beyond the threshold limit corresponding to that particular IMS element, such as a threshold for a particular P-CSCF 150. At a periodic interval (>=0), which may be preconfigured, the RegCount AS 162 may audit all the registered device 120 counts for each CSCF instance to identify any of the P-CSCF 150 instances that may have registered too many devices 120. The RegCount AS 162 may audit device 120 counts by comparing the device 120 counts to the base threshold and critical threshold, to determine if any device 120 count for a particular CSCF instance is greater than the configured threshold values for that CSCF instance. As the RegCount AS 162 performs the audit process in S40, the RegCount AS 162 may determine that a device 120 count for a first IMS instance (e.g. the P-CSCF 150A) is over threshold, and may perform a DNS update to indicate that registration with a second IMS instance (e.g. P-CSCF 150B) is preferred for any new device 120 registrations.

The audit interval may be set based on a historical number of devices 120 registering per period of time. For example, the audit interval may be set to be equal to one tenth of the registration interval. If the audit interval is too large, a large number of devices 120 may register between audit intervals, and the number of devices on the P-CSCF 150 may exceed the threshold and/or critical threshold. If the audit interval is too small, at the next audit, the RegCount AS 162 may discover that the threshold and/or critical threshold has been exceeded, and may need to initiate restorative measures to reduce the number of registered devices 120.

If an audit discovers that a base threshold limit has been reached, the RegCount AS 162 may update the priorities of the DNS server(s) 140, in step S41. That is, by updating a list of P-CSCF instances 150 in the DNS, an overloaded P-CSCF may be deprioritized in the DNS listing to limit further device 120 registrations with the overloaded P-CSCF. Another P-CSCF 150 may be prioritized by the DNS listing such that new devices 120 will register with the prioritized P-CSCF 150. This update of the DNS listing may prevent any additional registrations with the overloaded P-CSCF, by deprioritizing the IP address of the overloaded P-CSCF. If that update is not performed, the DNS server may continue to allow new devices 120 to register with the oversubscribed P-CSCF 150 that may be over its threshold, and the oversubscribed P-CSCF 150 may end up at or over the critical threshold, which may lead to system functionality problems.

For example, 80 DNS domains may be mapped to 8 different P-CSCFs 150. In that example, the DNS domains may be assigned to each P-CSCF 150 at 10:1 ratio. If one of those P-CSCFs 150 becomes overloaded or oversubscribed, one of the 10 DNS domains pointing to the overloaded or oversubscribed P-CSCF 150 may be updated to point to a different P-CSCF 150, so that the device 120 load may be balanced. By dynamically updating the DNS database in the DNS servers 140, the load on all the CSCF instances may be balanced over time as new devices 120 are directed to a different CSCF instance that is not overloaded or oversubscribed.

If, for example, after a periodic audit process in step S40, the RegCount AS 162 discovers that a particular IMS instance, such as the first or the primary P-CSCF-A (referred to generally as the IMS CSCF-150A), is oversubscribed, the RegCount AS 162 may perform a DNS update process by transmitting an update to the DNS server(s) 140. After the DNS server(s) 140 are updated in step S41, the next time a device 120 tries to register in step S42, the device 120 may be directed to a different P-CSCF 150. For example, after the device 120 performs a DNS lookup in step S42, the DNS server(s) 140 may respond with an IP address list prioritizing a different IMS instance, such as the second or secondary P-CSCF-B (referred to generally as IMS CSCF-150B) instead of the primary P-CSCF-A (IMS CSCF-150A). The device 120 may perform a registration process with newly prioritized the P-CSCF-B (IMS CSCF-150B), in steps S43-S46, in keeping with the process described with regards to steps S1-S22 of FIG. 2 above.

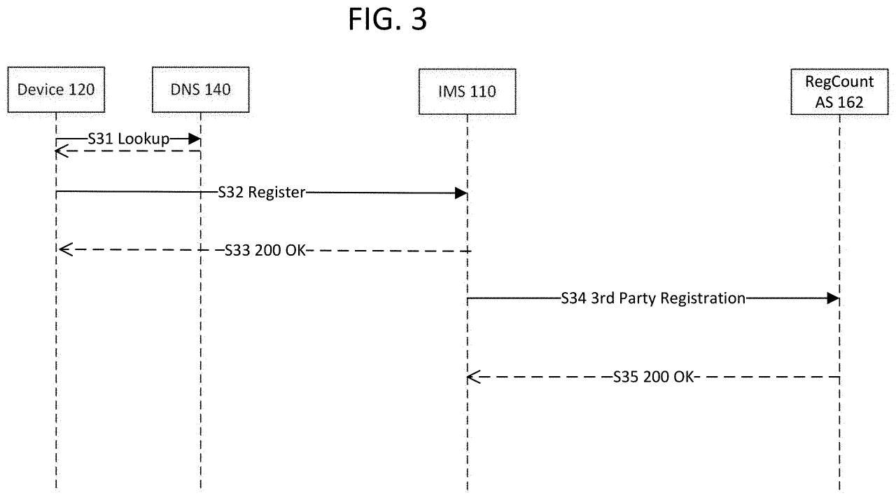

As the device 120 is registered with the P-CSCF-B (IMS CSCF-150B), the IMS core 110 element may perform a third party registration process in steps S47-S48, with the RegCount AS 162 on behalf of the device 120, in keeping with the process described with regards to steps S34-S35 of FIG. 3 above. The S-CSCF 152, of IMS core 110, may transmit a message which may include the complete registration message of the device 120 sent by the P-CSCF-B (IMS CSCF-150B) to the RegCount AS 162 as a payload in the body of the third party registration message. The RegCount AS 162 may perform a lookup operation of the device 120's identification information, in a local table or database, to determine if the device 120 has been previously added to the RegCount AS 162 database. As the device 120 was previously associated with the P-CSCF-A (IMS CSCF-150A), the RegCount AS 162 may update the device 120's entry in the RegCount AS 162 database with the new IMS-CSCF information. The RegCount AS 162 may update the device 120's expiry time, which indicates when the registration is going to expire, against the device 120 and may update the device 120 counts against the IMS count of P-CSCF-B (IMS CSCF-150B).

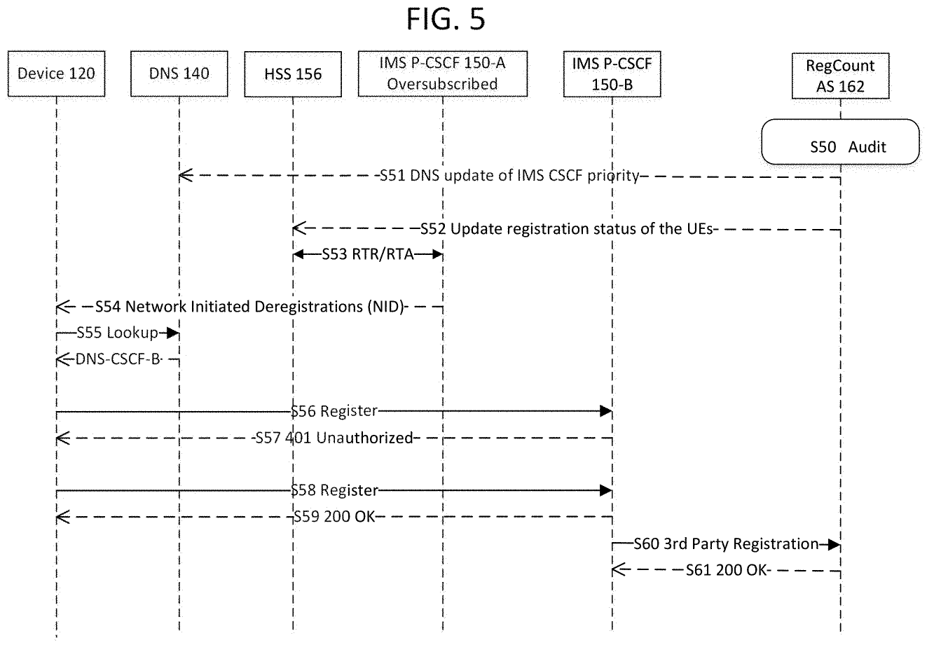

As shown in FIG. 5, the RegCount AS 162, independent of the device 120 registration processes, may perform an audit, at step S50, at the periodic interval. The RegCount AS 162 audit process may determine if any of the monitored P-CSCFs 150 have reached a registered number of the devices 120 beyond the threshold limit corresponding to that the particular P-CSCF 150. The RegCount AS 162 may audit the registered device 120 counts for each CSCF instance by comparing the registered device 120 counts to the base threshold and critical threshold, to determine if any device 120 count for that CSCF instance may be greater than the configured threshold values for that CSCF instance.

If an audit discovers that a critical threshold limit has been reached, the RegCount AS 162 may update the DNS server(s) 140, in step S51 (similar to step S41 of FIG. 4 discussed above), to prevent any additional registrations with the overloaded P-CSCF 150, by deprioritizing the IP address of the overloaded P-CSCF 150. If that update is performed, the DNS server(s) 140 may continue to allow new devices 120 to register with P-CSCF that may be over its threshold, and the critically oversubscribed P-CSCF 150 may develop system functionality problems. After the critical threshold limit has been reached, the RegCount AS 162 may take steps to reduce the number of devices 120 subscribed to the oversubscribed P-CSCF 150.

If, for example, based on a periodic audit process in step S50 by the RegCount AS 162, it is discovered that the P-CSCF-A (IMS CSCF-150A) is oversubscribed, the RegCount AS 162 may perform a DNS update process. After the DNS is updated in step S51, the next time a device 120 tries to register with the system, the device 120 may be directed to a different P-CSCF 150.

If a periodic audit process in step S50 by the RegCount AS 162 discovers that the P-CSCF-A (IMS CSCF-150A) is critically oversubscribed, the RegCount AS 162 may update, in step S52, the registration status of at least some devices 120 in the HSS 156, to terminate the registration status of the devices 120. The number of devices 120 whose registration may be terminated by the HSS update may be at least equal to the number of devices 120 by which the device 120 count is beyond the critical threshold or base threshold count value. That way, the device 120 count associated with the oversubscribed IMS element may be reduced so that the device 120 count is equal to base threshold value. The registration of the devices 120 that are approaching the end of their registration expiry timer may be terminated first.

Based on the RegCount AS 162 updating the registration status of at least one device 120 in the HSS 156, the HSS 156 may send Registration Termination Requests (RTR), in step S53, to the IMS-CSCF instance for each device 120 whose registration status is to be terminated. For example, the HSS 156 may send Registration Termination Requests to a critically oversubscribed IMS-CSCF-A (IMS CSCF-150A).

The termination requests may be used by the RegCount AS 162 to proactively move devices 120 to a different IMS-CSCF. After receiving the RTR, the critically oversubscribed IMS-CSCF-A (IMS CSCF-150A) may send out Network Initiated Deregistrations (NIDs), in step S54, to the affected devices 120. A device 120 receiving a NID from the IMS-CSCF may perform a new DNS lookup, in step S55, to discover the preferred IMS-CSCF instance for registration. Because the priorities have been updated in DNS server(s) 140, in step S51 by the RegCount AS 162, the device 120 may now be directed to register with a different IMS CSCF instance.

For example, the device 120 may perform a DNS lookup in step S55, and the DNS server(s) 140 may respond with an IP address list prioritizing P-CSCF-B (IMS CSCF-150B) instead of P-CSCF-A (IMS CSCF-150A). The device 120 may perform a registration process, in steps S56-S59, with newly prioritized P-CSCF-B (IMS CSCF-150B), using the registration process described above with regards to steps S1-S22 of FIG. 2. Because the device 120 is registered with P-CSCF-B (IMS CSCF-150B), the IMS core 110 element may perform a third party registration process, in steps S60-S61, with the RegCount AS 162 on behalf of the device 120, using the process described with regards to steps S34-S35 of FIG. 3 above. The IMS core 110 element may include the complete device 120 registration message sent by the P-CSCF-B (IMS CSCF-150B) to the RegCount AS 162, in step S60, as a payload in the body of the third party registration message. The RegCount AS 162 may perform a lookup operation of the device 120 identification information (e.g. an IMPI or IMPU), in a local table or database, to determine if the device 120 has been previously added to the RegCount AS 162 database. As the device 120 was previously associated with the P-CSCF-A (IMS CSCF-150A), the RegCount AS 162 may update the entry for the device 120 in the RegCount AS 162 database with the new IMS-CSCF information. The RegCount AS 162 may update the device registration expiry time, indicating when the registration of the device 120 is set to expire, and may update the registered device 120 counts against the IMS core 110 of the P-CSCF-B (IMS CSCF-150B).

Additionally or alternatively, a new overload subscription package may be provided to the devices 120 during an initial registration process. The overload subscription package provided to the devices 120 may dynamically deprioritize the first IP address provided by the DNS server(s) 140 during the initial registration process. If the device 120 is modified to include an overload subscription package, the device 120 may be notified (e.g. via a SIP NOTIFY message) by the RegCount AS 162 after an IMS-CSCF instance reaches its threshold capacity, as defined by a base threshold or critical threshold. The device 120, after receiving the notification, may begin to register with a different IMS CSCF instance during the next re-registration cycle. As such, the RegCount AS 162 may not need to update the DNS server(s) 140 to prevent any additional registrations with the overloaded P-CSCF 150, as the IP address of the overloaded P-CSCF 150 has been dynamically deprioritized in the device 120.

The RegCount AS 162 may perform a query of the status of the other available IMS-CSCF devices. As new IMS-CSCF instances are added or brought online, information including base and critical threshold values for the new IMS-CSCF instances may be provisioned to a RegCount AS 162 database. The RegCount AS 162 may determine the amount of users for each of the other P-CSCF devices and select a particular P-CSCF device to which additional devices may be registered. For example, the P-CSCF device with the most available capacity or least amount of users may be selected as the P-CSCF device to be prioritized for new device 120 registrations. As the capacity of each P-CSCF device may vary, the P-CSCF device to be prioritized may be the P-CSCF device with the largest percentage of available capacity to be prioritized for new device 120 registrations. The RegCount AS 162 may perform reprioritization of multiple of the DNS servers 140. When a P-CSCF 150 is serving a particular region, at least two DNS servers 140 pointing to that P-CSCF 150 may be updated to prioritize new devices 120 to register with different P-CSCF devices 150. The number of DNS servers 140 to be updated may be dependent on the footprint of the deployment.

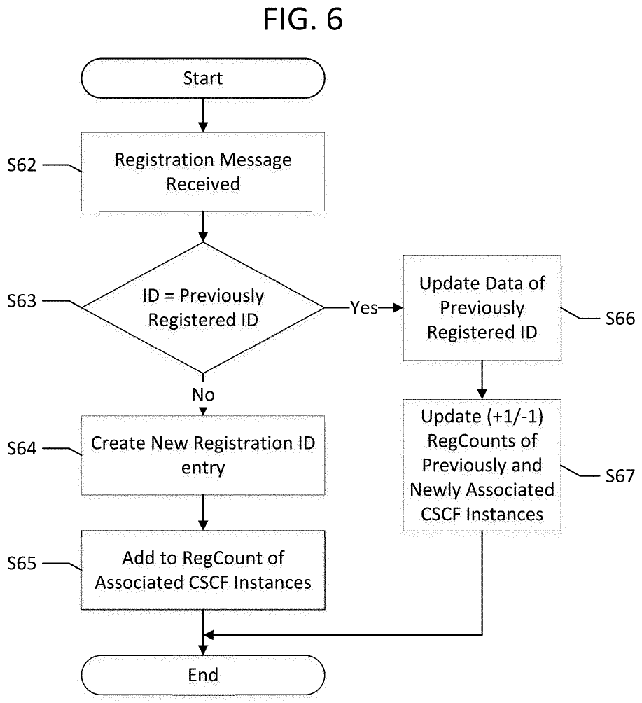

FIG. 6 shows an example of user registration count tracking by the RegCount AS 162. In step S62, the third party registration message may be received, in step S63, the RegCount AS 162 may determine whether the ID of the device 120 was previously registered. If the ID was not previously registered, in step S64 the RegCount AS 162 may create a new registration ID entry in the table or database, and the RegCount AS 162 may add to the RegCount of the CSCF instances associated with the device 120 being registered. If the ID is determined to have been previously registered, the RegCount AS 162 may update the date associated with the previously registered ID. In step S67, the RegCount AS 162 may update the registration counts of the associated CSCF instances. The updates may include lowering the registration count of the CSCF instances previously associated with the device 120, and increasing the registration count of the CSCF instances being currently associated with the device 120.

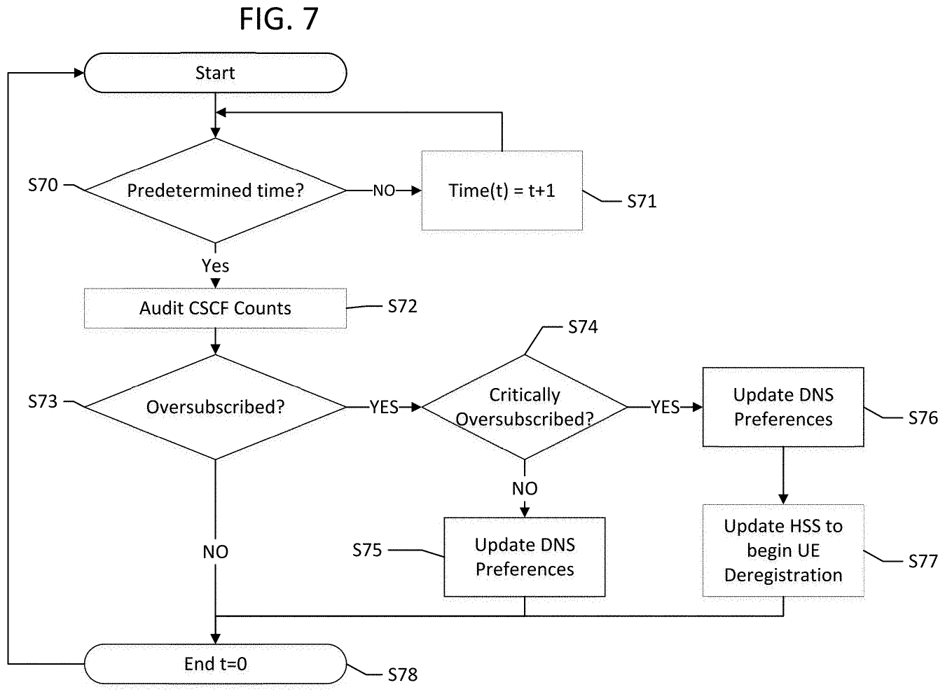

FIG. 7 shows an example Audit process by the RegCount AS 162. In step S70, the RegCount AS 162 may be running a timing process to determine if it is time to run the registration audit process. The audit process may be performed regularly, e.g., after a predetermined amount of time has elapsed. The audit process timing may be adjusted either by a system operator, or the system may have a tuning mechanism to automatically adjust the predetermined amount of time based on the frequency of occurrence of oversubscription events. The audit process timing may also have a tuning mechanism to automatically adjust the predetermined amount of time based on the percentage of capacity of the IMS element being used, so that the audit process is run more frequently when the element being audited is closer to its maximum capacity.

If the predetermined time has not been reached in step S70, the RegCount AS 162 may wait in step S71 until the predetermined time has been reached. Based on the predetermined time having been reached in step S70, the RegCount AS 162 may begin the audit process in step S72. The audit process may be a series of comparison operations for each CSCF instance in the system. For each CSCF instance, there may be an associated base threshold and critical threshold. A count of the number of registered devices 120 associated with a particular CSCF instance (CSCF RegCount) may be maintained and updated as the third party registration messages (See FIGS. 3 and 6) for devices 120 are received and processed for that CSCF instance. The CSCF RegCount may be compared to the base threshold and critical threshold of the CSCF instance.

In step S73, if the CSCF RegCount is greater than or equal to the base threshold, the RegCount AS 162 may proceed to determine if the CSCF RegCount may be greater than or equal to the critical threshold in step S74. If the CSCF RegCount is less than the critical threshold the RegCount AS 162 may proceed in step S75 to update the DNS preferences to deprioritize the subject CSCF instance (See step S41 of FIG. 4). Based on the updated DNS preferences, and for a new or previously registered device 120 performing a DNS lookup process (step S42, FIG. 4), the DNS server 140 may prioritize a different CSCF instance.

If the CSCF RegCount is greater than or equal to the critical threshold the RegCount AS 162 may proceed in step S76 to update the DNS preferences to deprioritize the subject CSCF instance (See step S41 of FIG. 4, or S51 of FIG. 5). Based on the updated DNS preferences, and for a new or previously registered device 120 performing a DNS lookup process (step S42, FIG. 4, and step S55, FIG. 5), the DNS server(s) 140 may prioritize a different CSCF instance, such as a backup IMS P-CSCF 150B. In step S77, the RegCount AS 162 may proceed to update the HSS 156 to begin device 120 deregistration. If a CSCF instance is critically oversubscribed, the RegCount AS 162 may proceed to alter the registration status of devices 120 associated with the critically oversubscribed CSCF instance to deregister devices 120 from the critically oversubscribed CSCF instance. After the RegCount AS 162 updates the registration status of at least some of the devices 120 in the HSS 156, the HSS 156 may send Registration Termination Requests (RTR) (see FIG. 5, step S53) to the CSCF instances for each device 120 whose registration status is to be terminated. The termination requests may be used by the RegCount AS 162 to cause the devices 120 to register with a different IMS-CSCF. Based on receiving the RTR, the critically oversubscribed CSCF instance may send out Network Initiated Deregistrations (NIDs) (see FIG. 5, step S54) to the affected devices 120. As the DNS server(s) 140 have been updated in step S76, the devices 120 may be directed to different CSCF instance. Because the devices 120 receiving NIDs begin a new registration process, the registered device 120 count of the critically oversubscribed CSCF may be gradually reduced until the device 120 CSCF RegCount of the affected CSCF instance is below both the associated critical and base thresholds.

In step S73, if the CSCF RegCount is less than the base threshold, the audit process for that CSCF instance ends, as the base threshold is lower than the critical threshold, and the RegCount AS 162 may wait until the predetermined time has been reached again. The end process may also keep track of the number of times that the CSCF instance has been determined to oversubscribed or critically oversubscribed, the frequency of the number of times the CSCF instance has reached an oversubscription, or critical oversubscription level. Those values may be used to evaluate the wait time amount between audits. Those values may also be used to change the base and critical threshold levels over time.

For the RegCount AS 162 to maintain valid data, a plurality of RegCount application servers may be provisioned as nodes of a server cluster. To guard against application, service, system, or hardware failures, each RegCount AS 162-N may frequently communicate with the other RegCount application servers, over network 180, in the cluster to maintain redundant and up to date data for the devices 120 registered with any RegCount AS 162. Each node of the cluster may communicate with the other nodes to perform load balancing of devices 120 across the CSCF instances. Each RegCount AS 162 may operate as an independent device in the manner described above.

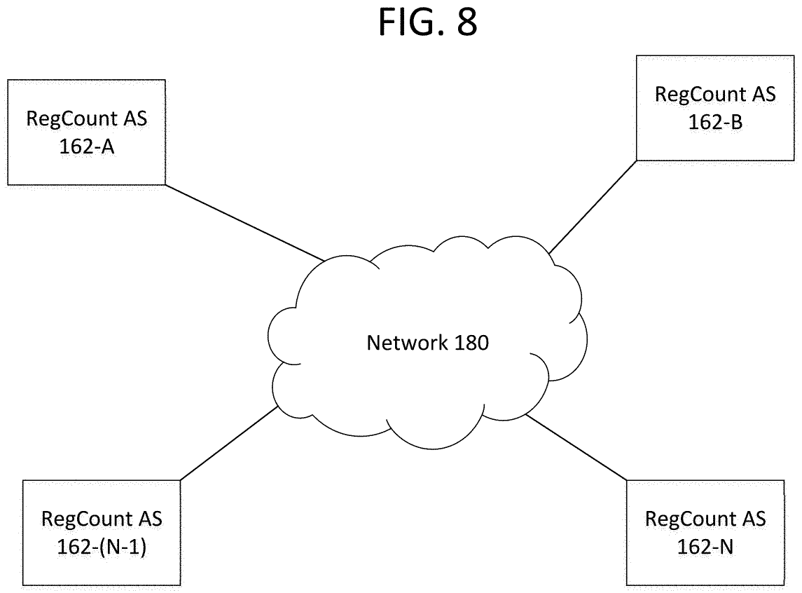

As shown in FIG. 8, a plurality of RegCount Application Servers 162-A through 162-N may be interconnected via a wide area network (WAN) 180, such as the Internet. Each RegCount AS 162-N may be associated with a particular IMS core 110, and may transmit periodic updates regarding the number of the devices 120 connected to each P-CSCF 150 to the other RegCount application servers. As such, each RegCount AS 162-N may maintain a consistent copy of a RegCount AS 162 database. With this information sharing, each RegCount AS 162-N may be able to track or query the number of the devices 120 assigned to each CSCF instances.

When a first CSCF instance reaches a threshold, new device 120 registration requests may be directed to a second CSCF instance based on available capacity of other CSCF instances. That selected CSCF instance may be located in a different location and associated with a different RegCount AS. For example, based on a threshold of a first P-CSCF device associated with RegCount AS 162-A being reached, the P-CSCF device to be selected as the P-CSCF device to be prioritized for new device 120 registrations may be associated with RegCount AS 162-B. The selection of the CSCF device to be prioritized for new registration requests may also be based on a combination of locations and available capacity of other CSCF devices.

As noted above, a RegCount AS may update DNS entries to de-prioritize an overloaded IMS CSCF instance, so that the overloaded IMS CSCF instance is not selected for device 120 registrations. The DNS server(s) 140 may be updated based on a message from RegCount AS 162-A to prioritize CSCF devices associated with RegCount AS 162-B. After the DNS server(s) 140 are updated, the next time a device 120 tries to register, the device 120 may be directed to a different IMS CSCF instance associated with RegCount AS 162-B.

A Network Initiated Deregistration (NID) may force the device 120 to re-register with IMS CSCF instances. The P-CSCF may transmit a deregistration message to the device 120 to be deregistered. The device 120 may attempt a new registration, beginning with a new DNS query. If the DNS server(s) 140 are updated based on a message from RegCount AS 162-A to prioritize the CSCF devices associated with RegCount AS 162-B, a deregistered device 120 trying to register may be directed to a different CSCF associated with the RegCount AS 162-B. As such, the re-registration requests may balance out registration of devices 120 across the IMS CSCF instances in the system.

Each component 120, 140, 150, 152, 154, 156, 160 and 162 may be any type of known computer, server, or computing device. One example of such a computing device is shown in FIG. 9 as a server 103. The server 103 may include a processor 111 controlling overall operation of the server 103. The server 103 may further include RAM 113, ROM 115, a network interface 117, input/output interfaces 119 (e.g., keyboard, mouse, display, printer, etc.), and memory 121. The I/O 119 may include a variety of interface units and drives for reading, writing, displaying, and/or printing data or files. The memory 121 may further store operating system software 123 for controlling overall operation of the computing device 103, control logic or software 125 for instructing the server 103 to perform steps or functions described herein, and other application software 127 providing secondary, support, and/or other functionality which may or may not be used in conjunction with other steps or functions described herein. The control logic may also be referred to herein as the server software 125. Functionality of the server software 125 may refer to operations or decisions made automatically based on rules coded into the control logic, made manually by a user providing input into the system, and/or a combination of automatic processing based on user input (e.g., queries, data updates, etc.). The software 125 may be executed by processor 111 and/or another processor to cause the server 103 to perform some or all of the features described herein.

The memory 121 may also store data used in performance of one or more steps or functions described herein, including a first database 129 and a second database 131. In some examples, the first database 129 may include the second database 131 (e.g., as a separate table, report, etc.). That is, the information may be stored in a single database, or separated into different logical, virtual, or physical databases, depending on system design. The devices 105, 107, 109, which may include other types of servers, data storage devices, personal computers, mobile devices, tablet computers, may have similar or different architecture as described with respect to the device 103. Those of skill in the art will appreciate that the functionality of the computing device 103 (or the devices 105, 107, 109) as described herein may be spread across multiple data processing devices, for example, to distribute processing load across multiple computers, to segregate transactions based on geographic location, user access level, quality of service (QoS), etc.

One or more features described herein may be embodied in computer-usable or readable data and/or computer-executable instructions, such as in one or more program modules, executed by one or more computers or other devices as described herein. Generally, program modules include routines, programs, objects, components, data structures, etc. that perform particular tasks or implement particular abstract data types when executed by a processor in a computer or other device. The modules may be written in a source code programming language that may be compiled for execution, or may be written in a scripting language such as (but not limited to) HTML or XML. The computer executable instructions may be stored on a computer readable medium such as a hard disk, optical disk, removable storage media, solid state memory, RAM, etc. As will be appreciated by one of skill in the art, the functionality of the program modules may be combined or distributed as desired in various examples. In addition, the functionality may be embodied in whole or in part in firmware or hardware equivalents such as integrated circuits, field programmable gate arrays (FPGA), and the like. Particular data structures may be used to more effectively implement one or more steps or features, and such data structures are contemplated within the scope of computer executable instructions and computer-usable data described herein.

Although examples are described above, features and/or steps of those examples may be combined, divided, omitted, rearranged, revised, and/or augmented in any desired manner. Various alterations, modifications, and improvements will readily occur to those skilled in the art. Such alterations, modifications, and improvements are intended to be part of this description, though not expressly stated herein, and are intended to be within the spirit and scope of the disclosure. Accordingly, the foregoing description is by way of example only, and is not limiting.

What is claimed is:

1. A method comprising:
receiving, by a first computing device, a registration message indicating both a second computing device and one or more third computing devices with which the second computing device is registered;
updating, after the receiving, a count, corresponding to the one or more third computing devices, of registered devices; and
causing, after the updating and based on a determination that the count satisfies at least one threshold value, a change to registration of computing devices for one or more services provided via the one or more third computing devices.

2. The method of claim 1, wherein the one or more third computing devices comprises one or more Call Session Control Function (CSCF) computing devices.

3. The method of claim 1, wherein the registration message indicates the second computing device by indicating an Internet Protocol (IP) Multimedia Private Identity (IMPI).

4. The method of claim 1, wherein the registration message indicates the second computing device by indicating an Internet Protocol (IP) Multimedia Public Identity (IMPU).

5. The method of claim 1, wherein the registration message indicates the one or more third computing devices by indicating a Proxy Call Session Call Function (P-CSCF) assigned to the second computing device.

6. The method of claim 1, wherein the registration message indicates the one or more third computing devices by indicating a Call Session Control Function (CSCF) Internet Protocol (IP) address assigned to second computing device.

7. The method of claim 1, wherein the updating comprises:
updating, based on a determination that the second computing device was previously registered in a user database, information in the user database for one or more Call Session Control Function (CSCF) computing devices previously associated with the second computing device.

8. The method of claim 1, wherein the updating comprises:
increasing, based on a determination that the second computing device was previously registered in a user database, the count, and
decreasing a count corresponding to a fourth computing device via which the one or more services are provided.

9. The method of claim 1, further comprising:
causing, after the updating, a confirmation message to be transmitted to the second computing device, wherein the confirmation message confirms registration with at least one Call Session Control Function (CSCF) device.

10. The method of claim 1, wherein causing the change to registration of computing devices for the one or more services comprises:
causing an update of one or more domain name server addressing priorities to deprioritize the one or more third computing devices.

11. The method of claim 1, further comprising:
comparing, by the first computing device and at predefined intervals, the count with a second threshold value; and
causing, based on a determination that the count satisfies the second threshold value, deregistration, of a plurality of computing devices, for the one or more services via the one or more third computing devices.

12. The method of claim 1, wherein the updating comprises:
updating, based on a determination that the second computing device was previously registered with the first computing device, information for one or more Call Session Control Function (CSCF) computing devices associated with the second computing device.

13. A method comprising:
receiving, by a first computing device, a registration message indicating a second computing device and one or more third computing devices;
updating, based on the registration message, a count corresponding to devices registered to receive one or more services via the one or more third computing devices;
comparing, after the updating, the count with at least one threshold value;
causing, based on the comparing, an update of one or more domain name server addressing priorities to deprioritize the one or more third computing devices.

14. The method of claim 13, wherein the one or more third computing devices comprise one or more Call Session Control Function (CSCF) computing devices.

15. The method of claim 14, further comprising:
causing, based on a determination that the count satisfies a second threshold value, deregistration, of a plurality of computing devices, for the one or more services via the one or more third computing devices.

16. The method of claim 14, wherein the updating comprises:
increasing, based on a determination that the second computing device was previously registered with the first computing device, the count corresponding to the one or more third computing devices, and
decreasing a count corresponding to another CSCF computing device.

17. The method of claim 14, wherein the registration message indicates the one or more third computing devices by indicating a CSCF Internet Protocol (IP) address assigned to second computing device.

18. A method comprising:
receiving, by a first computing device, registration messages indicating second computing devices and a plurality of third computing devices with which the second computing devices are registered;
comparing, by the first computing device, a count of a number of second computing devices registered with each of the plurality of third computing devices with a first threshold value associated with each of the plurality of third computing devices;
comparing, by the first computing device, the count of the number of second computing devices registered with each of the plurality of third computing devices with a second threshold value associated with each of the plurality of third computing devices; and
causing, based on a determination that that the count satisfies at least one of the first and second threshold values, a change to registration of computing devices for one or more services provided via the plurality of third computing devices.

19. The method of claim 18, wherein the causing comprises:
causing an update of one or more domain name server addressing priorities to deprioritize registration with at least one of the third computing devices.

20. The method of claim 18, wherein the causing comprises:
causing deregistration, of a plurality of computing devices, for one or more services via at least one of the third computing devices.
